(19) United States
(12) Patent Application Publication
(10) Pub. No.: US 2004/0179736 A1
(43) Pub. Date: Sep. 16, 2004

(54) Automatic classification and/or counting system

(76) Inventor: Jia Hong Yin, London (GB)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/715,335

(22) Filed: Nov. 17, 2003

Related U.S. Application Data
(63) Continuation of application No. PCT/GB02/02411, filed on May 23, 2002.

(30) Foreign Application Priority Data
May 26, 2001 (GB) 0112990.7

(51) Int. Cl. G06K 9/46

(52) U.S. Cl. 382/191; 382/224

(57) ABSTRACT

A system for automatically classifying and counting people, such as supermarket customers, and associated objects such as shopping trolleys. One or more video cameras view an area traversed by the customers and the video data is processed, in real time, to allocate each customer to one or more of a set of predetermined categories in dependence upon recognition criteria developed to permit reliable classification of customers in relation to the various categories.

### RELATED APPLICATION

This application is a continuation of International Application PCT/GB02/02411, filed May 23, 2002, the contents of which are here incorporated by reference in their entirety.

### BACKGROUND OF THE INVENTION

1. Field of the Invention

This invention provides a system for automatically classifying and/or counting people or objects. The invention is particularly, though not exclusively, applicable to the classification and/or counting of supermarket customers, by means of processing operations carried out upon data derived from video cameras used to monitor the entrance/exit areas of supermarkets.

2. Prior Art

Classifying into broad categories (e.g. to establish the proportion of customers using trolleys; those shopping alone or in groups; those with children; children alone and the proportion of male and female customers) and counting people entering and/or leaving supermarkets, for example, has much potential value, and many potential uses.

Store managers can, by correlation with other data, discern (amongst other things) the likely spend of different categories of customers, the kind of goods they habitually purchase, the time they spend in the store and so on, enabling improvements to be made with regard (among other things) to the provision and staffing of checkouts, the placement of goods relative to one another within the store, the location of preferred sites within the store for promotional materials, and the whereabouts of prime selling locations.

Much information of the requisite kind could, of course, be gathered manually by employing observers to directly monitor and note what is going on, but such activity is fraught with difficulties.

Apart from the fact that, by and large, people do not like being watched, and thus that any attempt to introduce observers would likely be counter-productive by driving customers away from the store, the degree of attention that needs to be continuously applied to the task, the rather tedious nature of the work and the subjective judgments that need to be made militate against the effectiveness of such arrangements and tend to make direct observation an unreliable source of data. Similar comments apply to the manual analysis of pre-recorded video footage.

International patent application No. PCT/GB97/02013 (Publication No. WO 98/08208) describes a proposal for automatically detecting the presence of customers, and their direction of motion, using a system of coarse analysis, carried out on data derived from a TV camera, followed by a detailed analysis of areas identified, during the coarse analysis, as containing customers. There is also a rudimentary attempt at customer classification, using plan-dimensional criteria checked against the content of a look-up table.

### SUMMARY OF THE INVENTION

An object of this invention is to provide a system that is capable of automatically processing, in real time, information derived from surveillance cameras to allocate customers amongst a predetermined series of categories, depending on selected recognition criteria. This, in turn, can lead to the development of information about the relative shopping habits of customers in the various categories. A further object is to provide such data in a manner that can be readily assimilated and interpreted by system users or by others commissioning or sponsoring the system's use.

According to this invention from one aspect, therefore, there is provided a classification and/or counting system comprising video means, sited to view an area of interest, and means for generating electrical signals representing video images of said area, characterized by the provision of processing means for processing said signals to discern identifiable recognition criteria therefrom, means for utilizing said criteria to directly classify, into at least one of a predetermined number of categories, objects entering and/or leaving the area of interest, and means utilizing the classification of said objects to provide an output indication relating respective said objects to respective said categories. The invention thus permits the objects to be classified in real time, and provides an output indicating, for example, the number of objects in each category over a predetermined time period (preferably a rolling or otherwise variable time period).

Preferably, the output indication is combined with other data relative to the environment of the area of interest in order to permit the assimilation of said indications into a wider pattern of data for comparison and evaluation.

The said area of interest may be located within the entrance/exit area of a supermarket or a department store. Alternatively, the area of interest may be associated with a transportation terminal, such as a railway station or an airport terminal for example.

It is further preferred that the area of interest comprises a floor area, and that the video images be derived, at least in part, from an overhead television camera mounted directly above the floor area. In this way, objects being monitored are presented in plan view to the camera, simplifying the recognition criteria needed to enable automatic classification and/or counting procedures to be implemented. Such arrangements also assist the automated sensing of motion.

Preferably, the categories into which objects are classified include the following:

Number of trolleys;

Number of groups;

Group sizes (in terms of numbers of people);

Number of children;

Number of adults;

Number of males with trolley;

Number of males without trolley;

Number of females with trolley;

Number of females without trolley; and

Number of adults of indeterminate sex.

It is further preferred that visual information is derived from two areas of interest for the purpose of customer classification and counting; the information derived from one of said areas being used for the (purely numerical) detection of people at the entrance, and their direction of motion; and that derived from the other area being used to classify and count them.

It is preferred that the information derived from said first area is subjected to processing including bi-directional block matching to detect the direction of motion of objects (e.g. customers) detected in said first area.

In preferred embodiments:

a. trolley detection is effected by using a line edge detector to detect lines, calculating the number of lines detected and comparing that number with a predetermined threshold value. If the number of lines counted reaches, or exceeds, the predetermined threshold, a trolley is detected and counted.

b. classification as between adult and child is preferably carried out: on the basis of images captured by an overhead camera, processing the plan images so produced to derive object boundaries, counting the number of pixels within each boundary and comparing the pixel numbers so counted with a predetermined threshold, dimensioned to distinguish in general between adults and children; and/or:

(ii) utilizing a camera that views the relevant area obliquely, and which can thus be used to capture images for adult and child classification based upon the measurement of height.

(c) group detection may be carried out to identify whether objects (e.g. customers) are individuals or part of a group; the number of people in the area preferably being calculated using conversion of the total number of pixels in a viewed area occupied by objects to number of people in the area by linear conversion function, and based upon measuring how close people are to one another.

(d) differentiation between male and female customers is preferably carried out on the basis of detection and classification of people's hair using images from an obliquely-mounted overhead camera. The procedure preferably involves head top detection, hair sampling and hair area detection; the areas detected being compared with thresholds predetermined for the classification.

Alternatively, or in addition, height measurement can be used to assist in the differentiation as between males and females.

### BRIEF DESCRIPTION OF THE DRAWINGS

In order that the invention may be clearly understood and readily carried into effect, certain embodiments thereof will now be described, by way of example only, with reference to the accompanying drawings, of which:

FIGS. 1 and 2 show, in block diagrammatic form, respective aspects of a system in accordance with one example of the invention;

FIGS. 3 to 9 and 11 to 13 show respective images derived from overhead or obliquely-mounted cameras and utilized in accordance with various aspects of the invention; and

FIG. 10 shows, in block diagrammatic outline form, certain elements of a technique for distinguishing between males and females on the basis of hair.

### DETAILED DESCRIPTION OF PREFERRED EMBODIMENTS OF THE INVENTION

In accordance with this example of the invention, a system for supermarket customer classification and counting contains one or more modules or units, conveniently referred to as “Smart Units” which have the requisite functionality for automatic customer classification and counting.

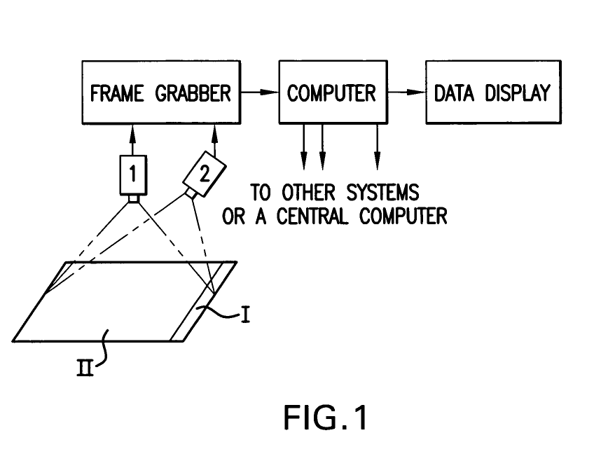

A Smart Unit may cope with the customer classification and counting for an entrance of the supermarket, as shown in FIG. 1. It comprises two cameras installed so that one of them (camera 1) looks directly down upon an area of interest, so as to view the area in plan, and the other (camera 2) is arranged to view the area of interest obliquely, from an inclination whose angle is selected for grabber, for simultaneously digitizing the two camera images, a computer and a display monitor. Multiple Smart Units may be installed and networked as a system for a big supermarket with multiple entrances. A central computer may be used to integrate data from the multiple Smart Units.

In this example of the invention, the data to be collected by the system is chosen to be as follows:

Number of trolleys;

Number of groups;

Group sizes (in terms of numbers of people);

Number of children;

Number of adults;

10 Number of males with trolley;

Number of males without trolley;

Number of females with trolley;

Number of females without trolley; and

Number of adults of indeterminate sex.

Two areas of interest I and II are defined at the entrance of a supermarket for the purpose of customer classification and counting. Area I is used for the (purely numerical) detection of people at the entrance, and their direction of motion, so that it can be determined whether the detected people are entering or leaving the supermarket. If people are detected as leaving, they are simply counted among the number of people leaving. If people are detected as entering, however, the information derived from area II is used to classify and count them.

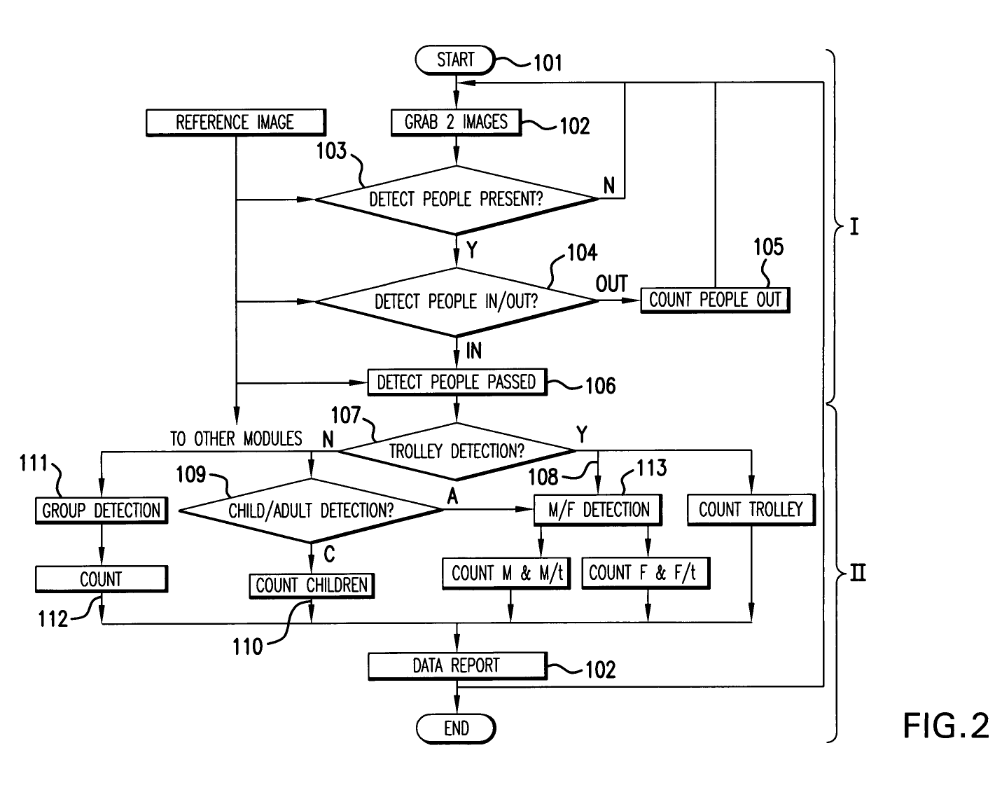

FIG. 2 shows a system flow chart, in which it can be seen that the first few stages are performed in relation to area I and the latter stages in relation to area II.

Following a Start instruction 101, a frame grabber grabs two images at 102 and the plan image of area I is compared at 103 with a reference image of the same area when empty, to detect whether any people are present in that area.

Alternatively, a more robust system may be provided in which the two plan images of area I are used to detect moving edges associated with people and/or objects in the area; the moving edge data being combined with the reference image by multiplication to detect the presence of people and/or objects in area I.

In either event, if there are no people in area I, the system is configured to grab two new images and restart the analysis. If at least one person is present, however, the direction of their movement is determined at 104, with people exiting being simply counted, at 105, as leaving the supermarket.

People determined as entering the supermarket, however, and counted accordingly at 106, are the subject of further analysis based upon processing of the data derived from area II.

Techniques based upon the difference between the content of successive frames, moving edge detection, background removal with a reference image, or their combination can be used to detect whether people are present in area I or have moved into area II.

Moreover, a technique utilizing the known procedure of bidirectional block matching is used to detect the direction (“in” or “out”) of the people detected in Area I. If people are detected as “out”, they are simply counted among the number of people exiting the supermarket. Otherwise, customer classification is carried out in Area II as follows.

Trolley Detection (107):

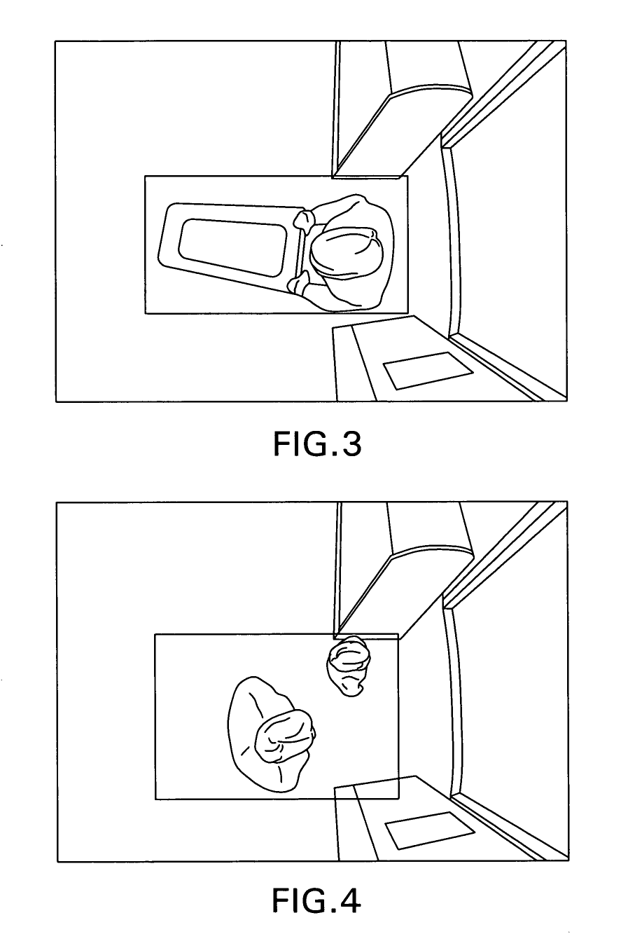

The plan images of trolleys are characterized by containing an unusually high number of relatively closely packed straight lines. Hence it has been found that efficient trolley detection can be achieved using a line edge detector to detect lines in the Area II, calculating the number of lines detected and comparing that number with a predetermined threshold value. An example is shown in FIG. 3, illustrating the straight lines of a trolley as detected. If the number of lines counted reaches, or exceeds, the predetermined threshold, a trolley is detected and counted at 108.

Classification as Between Adult and Child (109)—Method 1:

The overhead camera 1 can be used to capture images for classification as between adults and children. FIG. 4 is an example image containing an adult and a child.

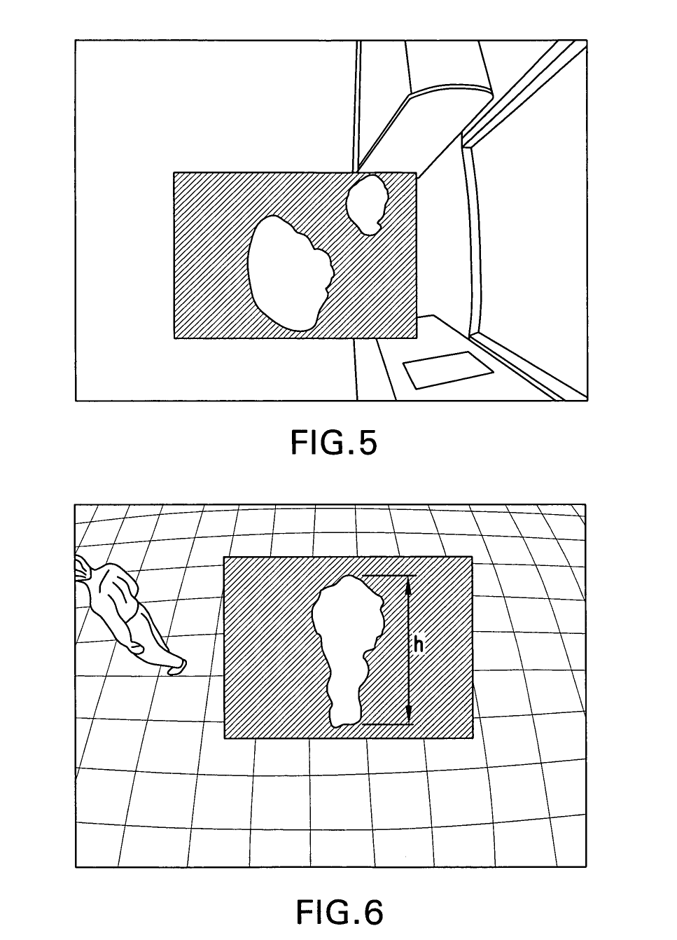

A reference image containing only background in the area of interest is used to assist in the extraction of the numbers of pixels respectively occupied by people in FIG. 4. The extracted pixels, shown in FIG. 5 as of grey intensity, can be grouped into areas with white boundaries occupied by individual people. The number of extracted pixels within each boundary can be used as an indication of the size of the area within the boundary and thus a child can, with reasonable reliability, be differentiated from an adult by comparing the pixel numbers extracted from the areas within different boundaries with a predetermined threshold, and children can be counted at 110.

Classification as between Adults and Children—Method 2

The following procedure can be used as an alternative to or in addition to the method described above.

It will be recalled that camera 2 views obliquely the area II, and it can thus be used to capture images for adult and child classification based upon the measurement of height. A reference image containing only background is used, as before, to assist in the extraction of pixels occupied by people. Assuming that people detected are standing upright, their height can be easily measured, as shown in FIG. 6. Thus adults and children can be identified according to the height of people in the image by comparing the evaluated heights with a predetermined or variable threshold value. The threshold value may vary depending on camera location and its angle.

In either event, the result of the evaluation at 109 is the production of an adult count A and a count C of children.

Group Detection (111):

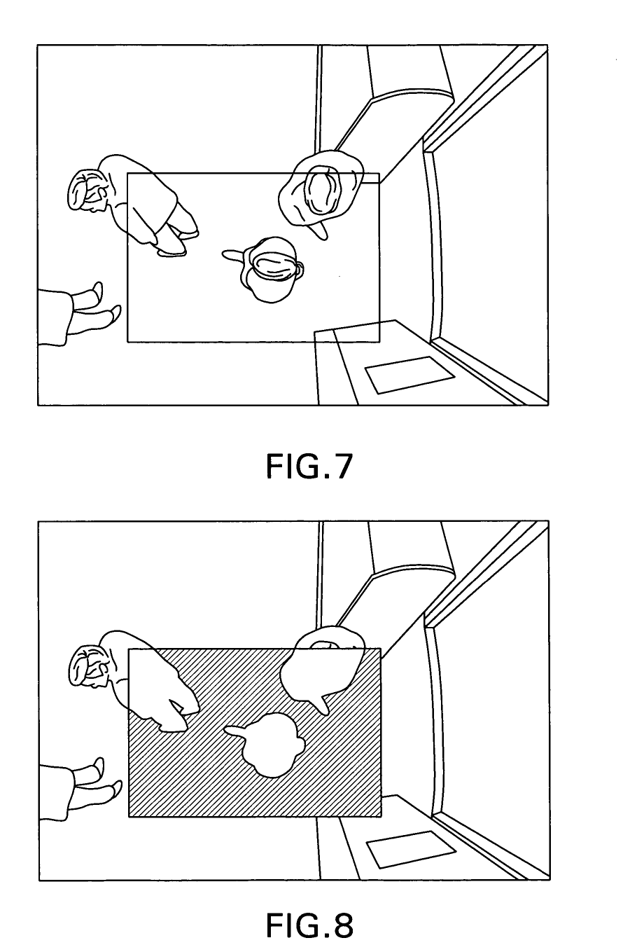

If the number of people in area II exceeds one, group detection is carried out to identify whether they are individuals or part of a group. The number of people in the area may be calculated using conversion of the number of pixels occupied by people to number of people by means of a linear conversion function, as is well known, and/or by using the counts (from 106) of people in area I that enter into area II. FIG. 7 shows three people in the area of interest, two of whom, because of their relative proximity, are assumed to comprise a group.

The method of identifying a group is thus based upon measuring how close people are to one another. The technique of background removal with a reference image is used, as before, to obtain an image with pixels occupied by people in the area, as shown in FIG. 8, from which it can be seen that there are two people classified at 112 as comprising one group.

Male and Female Detection (113):

Distinguishing males from females is usually very easy for human beings, because many varied criteria are subconsciously taken into account. The reliable distinction of males from females is, however, difficult to perform automatically on the basis of the operations of a computer upon visual images captured from cameras. As mentioned above, there are many features that can contribute to a greater or lesser extent to the identification of a person's gender. Styles and colors of clothes, shoes and heights are just a few of these factors. However, these features are tremendously various and very difficult to be classified.

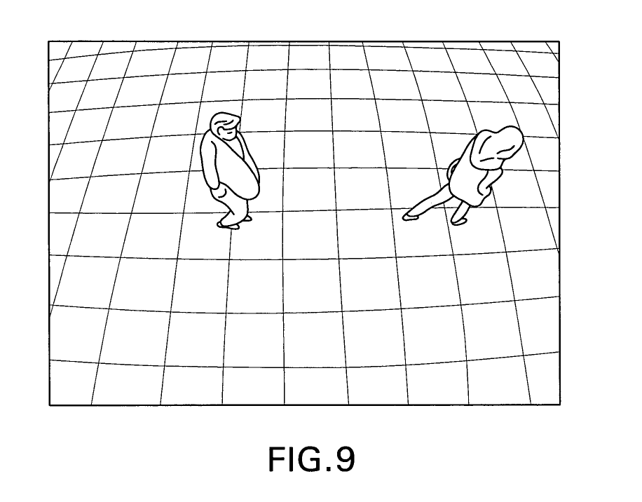

One criterion that has been found in practice to provide a reasonably reliable basis for differentiating between males and females is the detection and classification of people's hair using images from camera 2 in FIG. 1. FIG. 9 shows a typical difference of hair of a male and a female.

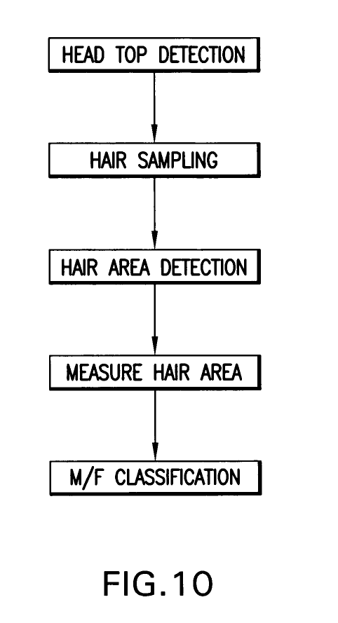

The algorithm for identifying male and female using hair detection is involved in the procedures in FIG. 10. It may of course prove impossible in some instances to identify gender on this basis; nevertheless the data from those that can be identified is very valuable for supermarket management and product promotion.

Head Top Detection:

Using the hypothesis that people walking/standing are generally upright, the top of head is easy to detect using techniques of inter-frame difference and/or background removal as discussed previously.

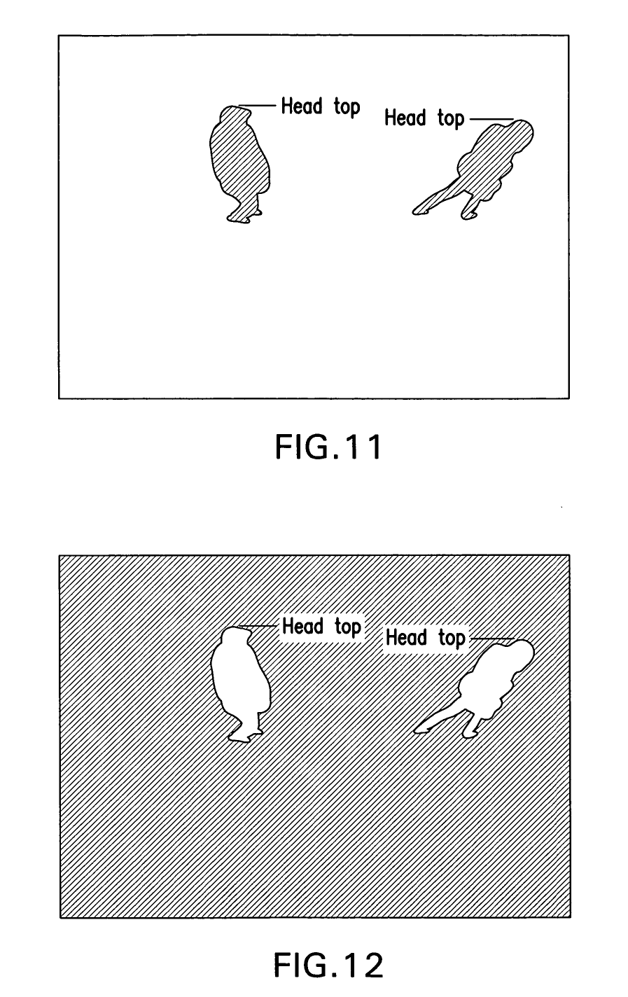

FIG. 11 shows the technique for head top detection using the inter-frame difference between two consecutive images.

FIG. 12 shows the technique for head top detection using background removal that moves the background pixels from the image containing people by comparing it with a reference image.

Hair Sampling:

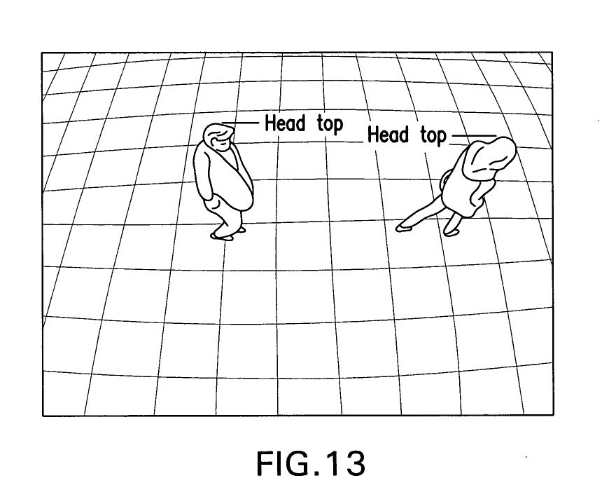

Since people's hair has different features in terms of color and brightness/darkness, the images of hair have to be sampled to detect the hair area. As an example, hair pixel intensity and/or color is used as a hair sample characteristic. The pixels near the head top are hair pixels presenting hair intensity and/or color. A small area containing the hair pixels is used as a hair sample of the image, as shown in FIG. 13.

Hair Area Detection:

The hair sample is used to find the whole area of hair in image, utilizing techniques, known in themselves, of intensity template matching or color template matching.

FIG. 13 shows an example of hair detection and measurement.

Measurement of Hair Area:

The hair area detected can be measured by counting the number of pixels in the hair area.

Male and Female Classification:

Using the assumption that females have long hair and males have short hair, the hair areas of females are larger than those of males. A set of thresholds is predetermined for the classification. For example, if two thresholds (T1>T2) are used, a female is identified if the hair area is larger than T1, and male is identified if the hair area is smaller than T2. The sex of a person may be classified as indeterminate if the measured hair area is between T1 and T2.

Using this approach, it is also possible to identify males who do not have hair at all, by measuring their head areas.

By Height Measurement:

If it is assumed that males are in general taller than females, the technique for measuring height, as described above, can be used to identify males and females to a certain extent. If this technique is used, it may supplement or replace that of hair area measurement described above.

By Reflection Measurement:

Apart from using imaging techniques, other means may be used to identify, and/or assist in the identification, of males and females. It may be right to assume that females like to wear skirts in the most of year except winter. In this case, portions of their legs are exposed. Assuming that reflection of infrared, microwave and/or ultrasonic energy differs as between trousers and legs, other sensors can be used in the system. Infrared sensor can be used to measure the temperatures of trousers and legs. Microwave generators and sensors, or ultrasonic generators and sensors, can be used to measure the reflection of microwave or ultrasonic energy.

Reference Image:

A reference image is an image containing only background in the area of interest, used in image processing to extract objects from the background. To overcome the problem caused by lighting change, it is automatically updated if any lighting changes.

The various counts produced at the stages 107 to 113 and at the un-numbered blocks labeled “count” in FIG. 2 can be combined in any suitable logical way to provide classified input signals permitting the generation of a data report which is indicative of the distribution of customers amongst the various categories addressed by the analysis.

In this particular example, whilst the counts of trolleys, groups and children are derived as straightforward outputs from the respective “count” stages, the counts of males (M), males with trolleys (M/t), females (F) and females with trolleys (F/t) are derived at 113 by processing the output A from stage 109 and the output from stage 107.

It will be appreciated that the principles of the invention are in no way limited to the supermarket application 35 described above in detail. As mentioned previously, the invention can also be applied, for example to areas such as the counting and classification of people at transport termini, and there are indeed other applications in which the objects classified need not be people at all.

In one particularly beneficial application of the invention, it finds use in the classification of objects such as debris on critical vehicle paths, such as airport runways.

What is claimed is:

1. A classification and/or counting system comprising video means sited to view an area of interest, and means for generating electrical signals representing video images of said area, characterized by the provision of processing means for processing said signals to discern identifiable recognition criteria therefrom, means for utilizing said criteria to directly classify, into at least one of a predetermined number of categories, objects entering and/or leaving the area of interest, and means utilizing the classification of said objects to provide an output indication relating respective said objects to respective said categories.

2. A system according to claim 1 wherein the output indication is combined with other data relative to the environment of the area of interest in order to permit the assimilation of said indications into a wider pattern of data for comparison and evaluation.

3. A system according to claim 1 wherein the area of interest comprises a floor area, and the video images are derived, at least in part, from an overhead television camera mounted directly above the floor area.

4. A system according to claim 1 wherein said area of interest is located within the entrance/exit area of a supermarket or a department store and wherein said objects comprise customers and trolleys.

5. A system according to claim 1 wherein visual information is derived from first and second regions of said area of interest for the purpose of customer classification and counting; the information derived from said first region being used for the detection of people at the entrance and their direction of motion; and that derived from the second region being used to classify and count them.

6. A system according to claim 5 wherein the information derived from said first region is subjected to processing including bidirectional block matching to detect the direction of motion of objects detected therein.

7. A system according to claim 4 wherein the categories into which objects are classified includes at least one of: number of trolleys; number of groups; group sizes (in terms of numbers of people); number of children; number of adults; number of males with trolley; number of males without trolley; number of females with trolley; number of females without trolley; and number of adults of indeterminate sex.

8. A system according to claim 4 wherein trolley detection is effected by using a line edge detector to detect lines, calculating the number of lines detected and comparing that number with a predetermined threshold value.

9. A system according to claim 4 wherein classification as between adult and child is carried out on the basis of images captured by an overhead camera, processing the plan images so produced to derive object boundaries, counting the number of pixels within each boundary and comparing the pixel numbers so counted with a predetermined threshold, dimensioned to distinguish in general between adults and children.

10. A system according to claim 4 wherein classification as between adult and child is carried out utilizing a camera that views obliquely, and which is used to capture images for adult and child classification based upon the measurement of height.

11. A system according to claim 4 wherein group detection is carried out to identify whether objects (e.g. customers) are individuals or part of a group; based upon measuring the proximity of people to one another.

12. A system according to claim 4, wherein differentiation between male and female customers is carried out on the basis of detection and classification of people's hair using images derived from an obliquely mounted camera.

13. A system according to claim 12 wherein the procedure for detection and classification of hair comprises head top detection, hair sampling and hair area detection; and comparison of the areas detected with predetermined thresholds.

14. A system according to claim 12 wherein height measurement is used to assist in the differentiation as between males and females.

15. A system according to claim 4 wherein differentiation between male and female customers is carried out on the basis of detection and classification of energy reflected from customers' anatomy.

16. A system according to claim 1 wherein the area of interest is associated with a transportation terminal, such as a railway station or an airport terminal.
